(19) United States
(12) Patent Application Publication
(10) Pub. No.: US 2025/0316092 A1
(43) Pub. Date: Oct. 9, 2025

(54) DRIVING ASSISTANCE DEVICE, ROAD-TO-VEHICLE DRIVING ASSISTANCE SYSTEM, AND DRIVING ASSISTANCE METHOD

(71) Applicant: Mitsubishi Electric Corporation, Tokyo (JP)

(72) Inventors: Daichi TSUNEMICHI, Tokyo (JP); Shintaro WATANABE, Tokyo (JP)

(73) Assignee: Mitsubishi Electric Corporation, Tokyo (JP)

(21) Appl. No.: 18/865,687

(22) PCT Filed: May 20, 2022
(86) PCT No.: PCT/JP2022/020904

§ 371 Date: Nov. 14, 2024

(51) Int. Cl. G06V 20/58; G06V 10/75; G06V 10/764; G06V 20/40; G06V 20/59; G06V 40/18; G08G 1/01; G08G 1/16; H04N 7/18

(52) U.S. Cl. CPC G06V 20/58; G06V 10/751; G06V 10/764; G06V 20/40; G06V 20/59; G06V 40/18; G08G 1/0116; G08G 1/16; H04N 7/183

(57) ABSTRACT

A driving assistance device includes a line-of-sight information calculating unit to calculate line-of-sight information of a subject from a vehicle interior video, a target object information calculating unit to detect a target object present around the vehicle from a vehicle exterior video and extract target object information, a visibility calculating unit to calculate a visibility indicating a degree of visual recognition of the detected target object by the subject from the calculated line-of-sight information and the extracted target object information, a collision possibility calculating unit to calculate a collision possibility indicating a degree of collision possibility between the detected target object and the vehicle from the extracted target object information, and an effective collision possibility calculating unit to calculate an effective collision possibility from the calculated visibility and the calculated collision possibility.

### TECHNICAL FIELD

The present disclosure relates to a driving assistance technology.

### BACKGROUND ART

Patent Literature 1 discloses a driving assistance device including a visibility calculating unit that calculates, on the basis of a direction of a line of sight of a driver of a vehicle and information of one or more target objects present around the vehicle, a first visibility that is a degree of visibility of the driver of the vehicle to each of the one or more target objects, a risk calculating unit that calculates a risk level indicating a possibility of contact of the vehicle with each of the one or more target objects on the basis of a state of each of the one or more target objects and a state of the vehicle, and a display control unit that causes first warning information to be displayed in association with a first target object on a display unit when the first visibility of the first target object among the one or more target objects is less than a first threshold, and causes the first warning information to be hidden when the first visibility is equal to or more than the first threshold, in which the display control unit causes, when the first warning information is not displayed on the display unit and the risk level of the first target object is equal to or more than a second threshold, second warning information for the first target object to be displayed on the display unit in association with the first target object.

As described above, with the driving assistance device of Patent Literature 1, after determining whether or not the first visibility of the first target object is less than the first threshold and performing display control of the first warning information, the display control unit performs display control to display the second warning information when the risk level of the first target object is equal to or more than the second threshold in a state where the first warning information is not displayed.

### CITATION LIST

### Patent Literature

Patent Literature 1: JP 2020-166542 A

### SUMMARY OF INVENTION

### Technical Problem

With a configuration in which the risk level is additionally evaluated on the premise that the visibility is evaluated as in the driving assistance device of Patent Literature 1, there is a problem that it is not possible to simultaneously evaluate the visibility and the risk level (collision possibility) and perform warning.

The present disclosure has been made to solve such a problem, and an object of the present disclosure is to provide a driving assistance technique capable of simultaneously evaluating visibility and collision possibility and performing warning.

### Solution to Problem

One aspect of a driving assistance device according to an embodiment of the present disclosure includes a line-of-sight information calculating unit to calculate line-of-sight information of a subject from a vehicle interior video about inside a vehicle captured by an imaging device including at least one camera, a target object information calculating unit to detect a target object present around the vehicle from a vehicle exterior video about outside the vehicle captured by the imaging device and extract target object information that is information of the detected target object, a visibility calculating unit to calculate a visibility indicating an extent of a degree of visual recognition of the detected target object by the subject from the calculated line-of-sight information and the extracted target object information, a collision possibility calculating unit to calculate a collision possibility indicating an extent of a degree of collision possibility between the detected target object and the vehicle from the extracted target object information, and an effective collision possibility calculating unit to calculate an effective collision possibility that decreases in accordance with an increase in the calculated visibility and increases in accordance with an increase in the calculated collision possibility from the calculated visibility and the calculated collision possibility.

### Advantageous Effects of Invention

According to one aspect of the driving assistance device according to embodiments of the present disclosure, it is possible to simultaneously evaluate a visibility and a risk level and to perform warning.

### BRIEF DESCRIPTION OF DRAWINGS

FIG. 1 is a block diagram illustrating a driving assistance device and a driving assistance system according to a first embodiment of the present disclosure.

FIG. 2 is a flowchart for describing an operation for providing driving assistance according to the first embodiment of the present disclosure.

FIG. 3 is a block diagram illustrating a driving assistance device and a driving assistance system according to a second embodiment of the present disclosure.

FIG. 4 is a diagram illustrating a specific example for describing a concept of an effective collision possibility regarding the driving assistance device and the driving assistance system according to the first and second embodiments of the present disclosure.

FIG. 5 is a diagram illustrating a configuration example of a roadside system including a roadside device according to a third embodiment of the present disclosure.

FIG. 6A is a diagram illustrating a configuration example of hardware of the driving assistance device and the roadside device according to the first to third embodiments of the present disclosure.

FIG. 6B is a diagram illustrating a configuration example of hardware of the driving assistance device and the roadside device according to the first to third embodiments of the present disclosure.

### DESCRIPTION OF EMBODIMENTS

Hereinafter, various embodiments of the present disclosure will be described in detail with reference to the accompanying drawings. Note that components denoted by the same or similar reference numerals in the drawings have the same or similar configurations or functions, and redundant description of such components will be omitted.

### First Embodiment

### <Configuration>

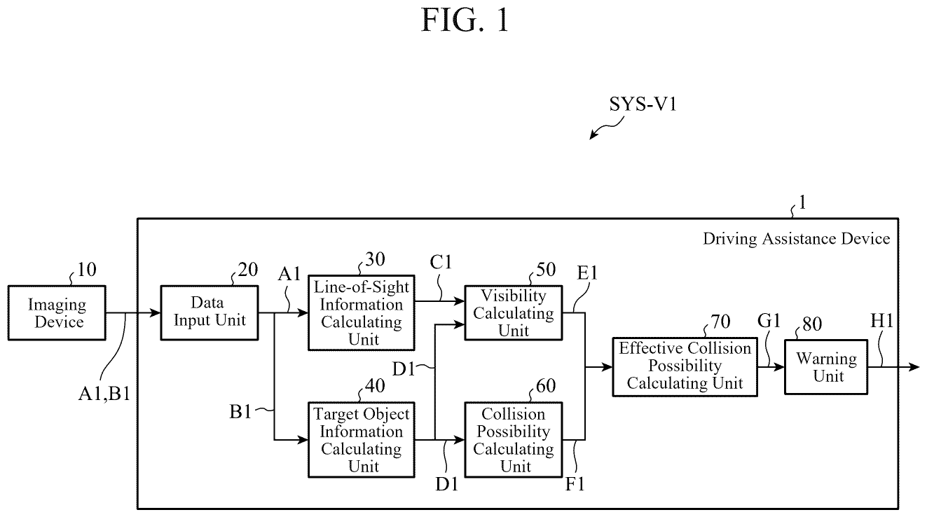

A driving assistance device 1 and a driving assistance system SYS-V1 according to a first embodiment of the present disclosure will be described with reference to FIG. 1. FIG. 1 is a block diagram illustrating the driving assistance device 1 and the driving assistance system SYS-V1 according to the first embodiment of the present disclosure. As illustrated in FIG. 1, the driving assistance system SYS-V1 includes an imaging device 10 that captures a vehicle exterior video including a visual target object and a vehicle interior video including a subject, and the driving assistance device 1.

As an example, the driving assistance device 1 includes a data input unit 20 that receives images captured by the imaging device 10 as inputs, classifies the images into a vehicle interior video and a vehicle exterior video necessary for calculation of line-of-sight information and target object information, and outputs the classified images, a line-of-sight information calculating unit 30 that calculates line-of-sight information of a subject from the vehicle interior video, a target object information calculating unit 40 that detects a target object around the vehicle from the vehicle exterior video and extracts information of the target object, a visibility calculating unit 50 that calculates a visibility in consideration of time-series attenuation from the line-of-sight information and the target object information, a collision possibility calculating unit 60 that calculates a collision possibility of the target object from the target object information, an effective collision possibility calculating unit 70 that calculates an effective collision possibility from the visibility and the collision possibility, and a warning unit 80 that determines and presents contents of warning in accordance with the effective collision possibility. All functional units of the driving assistance device 1 may be implemented by a device mounted on the vehicle, or only some functional units of the driving assistance device 1 may be implemented by a device mounted on the vehicle, and the remaining functional units may be implemented by a device provided remotely. Hereinafter, the vehicle on which the driving assistance device 1 is mounted is referred to as a device-mounted vehicle.

(Imaging device)

The imaging device 10 includes at least one camera, captures vehicle interior video A1 including a plurality of frame images including a face image of a subject in the vehicle and vehicle exterior video B1 including a plurality of frame images including a target object to be visually recognized by the subject, and outputs video data including the vehicle interior video A1 and the vehicle exterior video B1. The vehicle interior video A1 and the vehicle exterior video B1 may be captured as individual videos using a single camera related to each video, or may be captured using a stereo camera related to each video in order to measure an accurate three-dimensional position. In addition, the vehicle interior video A1 and the vehicle exterior video B1 may be collectively captured in the same video by using a camera capable of capturing a wide range, such as an omnidirectional camera. The imaging device 10 is connected to the data input unit 20 of driving assistance device 1.

### (Data Input Unit)

The data input unit 20 classifies video data including the vehicle interior video A1 and the vehicle exterior video B1 into the vehicle interior video A1 necessary for calculation of line-of-sight information and the vehicle exterior video B1 necessary for calculation of target object information, and outputs the classified vehicle interior video A1 and vehicle exterior video B1. The data input unit 20 is connected to the line-of-sight information calculating unit 30 and the target object information calculating unit 40, outputs the vehicle interior video A1 to the line-of-sight information calculating unit 30, and outputs the vehicle exterior video B1 to the target object information calculating unit 40.

### (Line-of-Sight Information Calculating Unit)

The line-of-sight information calculating unit 30 receives the vehicle interior video A1 as an input, calculates a line-of-sight vector of the subject from the received vehicle interior video A1, and outputs the calculated line-of-sight vector as line-of-sight information C1. As a method of calculating the line-of-sight vector, a model-based line-of-sight detection method typified by use of a corneal reflection image may be used, or an appearance-based method by machine learning may be used. The line-of-sight information calculating unit 30 is connected to the visibility calculating unit 50.

(Target object information calculating unit)

The target object information calculating unit 40 receives the vehicle exterior video B1 as an input, detects a target object that needs to be visually recognized in performing appropriate driving from the received vehicle exterior video B1, and outputs target object information D1 that is information regarding the detected target object. Type information indicating the type of the target object may be used as the target object information D1, such as “fixed indicator” when the target object is a traffic signal, and “moving object” when the target object is an automobile or a pedestrian. When the target object is a fixed indicator, the target object information D1 may further include position information indicating a position of the target object, size information indicating a detected size of the target object, and state information typified by a lighting mode of a light-emitting diode (LED). On the other hand, when the target object is a moving object, the target object information D1 may further include position information indicating the position of the target object, size information indicating the detected size of the target object, and time-series change information (motion information) indicating the traveling direction and speed of the target object. The target object information calculating unit 40 is connected to the visibility calculating unit 50 and the collision possibility calculating unit 60, and outputs the target object information D1 to both.

### (Visibility Calculating Unit)

The visibility calculating unit 50 receives the line-of-sight information C1 and the target object information D1 of the subject as inputs, calculates a visibility E1 to each target using the received line-of-sight information C1 and target object information D1, and outputs the calculated visibility E1. The visibility E1 is an index indicating the extent of the degree to which the subject visually recognizes the detected target object. The visibility calculating unit 50 calculates the visibility E1, for example, as follows.

First, the visibility calculating unit 50 calculates a direction matching degree between vectors by using a line-of-sight unit vector of the line-of-sight vector and a target unit vector of the target vector from the vehicle toward the target object at each time. As the direction matching degree, the degree of an angle formed by the line-of-sight unit vector and the target unit vector may be used, or the degree of an angle formed by two unit vectors in a displacement direction per unit time of those two unit vectors may be used. The direction matching degree may be an index smoothed per certain time.

Next, the visibility calculating unit 50 goes back by a certain time from the current time toward the past and calculates the sum of direction matching degrees given a weight of each time. The weight may be set to be higher toward the current time, or a non-linear weight may be given. In a case where a state change or a motion change of the target object is observed within a measurement time of the visibility, a correction coefficient is defined for each type of the target object, the direction matching degree before the time when the change of the target object occurs is multiplied by the correction coefficient, and a sum of corrected direction matching degrees within the measurement time is obtained to calculate the visibility. In a case where the target object is a fixed indicator represented by a traffic signal, the correction coefficient may be given by a constant multiple at the time when the indication content changes. When the target object is a moving object represented by an automobile, a difference between a motion at the start of visibility measurement and a motion at the current time may be calculated, and the correction coefficient may be dynamically defined depending on the amount of the difference. The visibility calculating unit 50 is connected to the effective collision possibility calculating unit 70.

### (Collision Possibility Calculating Unit)

The collision possibility calculating unit 60 receives the target object information D1 as an input, calculates a collision possibility F1 with respect to each target object using the received target object information D1, and outputs the calculated collision possibility F1. The collision possibility F1 is an index indicating the degree of possibility that the detected target object collides with the device-mounted vehicle. When the collision possibility F1 is calculated, the calculation method may be changed depending on the type of the target object indicated by the type information. For example, in the case of a fixed indicator represented by a traffic signal, a time limit to a stop instruction position is measured from the position and motion information of the target object, and the collision possibility F1 is defined as an index inversely proportional to the time limit. The time limit may be multiplied by a correction coefficient depending on a difference in instruction form from go to stop. Here, examples of the instruction form of the target object include color display of a traffic signal, information about a road on a road information board (traffic congestion, traffic accidents, weather, or the like), and the like. Further, as an example, the motion information is information regarding the speed, acceleration, and traveling direction of the target object. Even if the target object is a fixed object such as a signal, the target object appears to be relatively moving when viewed from a camera attached to the vehicle, and thus motion information is present.

When the target object is a moving object such as an automobile, a time limit until coming into contact with the device-mounted vehicle is measured from the position and motion information of the target object, and a collision possibility F1 is defined as an index inversely proportional to the time limit. Furthermore, in a case where the target object is a moving object, kinetic energy may be calculated, and the collision possibility F1 may be defined as an index proportional to the kinetic energy.

In this manner, the collision possibility calculating unit 60 selects at least one of the instruction form or the motion information of the target object depending on the type of the target object, and calculates the collision possibility F1. The collision possibility calculating unit 60 is connected to the effective collision possibility calculating unit 70.

(Effective collision possibility calculating unit)

The effective collision possibility calculating unit 70 receives the visibility E1 and the collision possibility F1 as inputs, calculates an effective collision possibility G1 using the received visibility E1 and collision possibility F1, and outputs the calculated effective collision possibility G1. The effective collision possibility G1 is an index that decreases in accordance with an increase in the visibility E1 and increases in accordance with an increase in the collision possibility F1. The visibility E1, which is such an index, is expressed as, for example, Equation (1). Here, K is a constant. The effective collision possibility calculating unit 70 is connected to the warning unit 80.

G1=K×F1/(1+E1) (1)

As expressed in Expression (1), the effective collision possibility G1 decreases when the collision possibility F1 is constant and the visibility E1 increases. Conversely, the effective collision possibility G1 increases when the visibility E1 is constant and the collision possibility F1 increases. Since the visibility E1 and the collision possibility F1 are included in a single equation, they can be evaluated simultaneously.

With the configuration in which the risk level is additionally evaluated on the premise that the visibility is evaluated as in Patent Literature 1, there is a problem that the visibility and the risk level (collision possibility) cannot be simultaneously evaluated and a warning cannot be issued. On the other hand, with the configuration according to the first embodiment including the effective collision possibility calculating unit 70, it is possible to simultaneously evaluate the visibility E1 and the collision possibility F1 as the effective collision possibility G1. By using such an effective collision possibility G1, it is possible to issue a warning in which the visibility E1 and the collision possibility F1 are simultaneously evaluated.

By performing the warning in which the visibility E1 and the collision possibility F1 are evaluated at the same time, it is possible to eliminate annoyance to the user that can be caused by the configuration of Patent Literature 1. That is, with the configuration of performing display control of displaying the second warning information when the risk level of the first target object is equal to or more than the second threshold in a state where the first warning information is not displayed after determining whether or not the first visibility of the first target object is less than the first threshold and performing display control of the first warning information as in Patent Literature 1, the determination as to whether or not to display the warning information (first warning information) is made depending on whether or not the visibility (first visibility) is equal to or more than the threshold (first threshold) when the risk level of the target object (first target object) is less than the threshold (second threshold), and thus there is a problem that the warning display is made and the user of the device feels annoyed when the visibility of the target object having a low risk level (that is, the target object of which the risk level is less than the second threshold) is low (that is, the visibility is less than the first threshold). On the other hand, with the configuration according to the first embodiment including the effective collision possibility calculating unit 70, the relationship of the visibility E1 and the collision possibility F1 is evaluated at the same time as the effective collision possibility G1, and thus, for a target object whose collision possibility F1 is lower, the visibility E1 satisfying the threshold of the effective collision possibility G1 becomes lower. Therefore, for a target object whose collision possibility F1 is lower, unnecessary warning can be suppressed by satisfying the visibility E1 related thereto.

In addition, in a case where the collision possibility is medium and constant, it is difficult to determine whether to make the subject (driver) actually pay attention or leaving the subject (driver) causes no problem, if the collision possibility only is considered without taking the visibility into consideration. In such a case, the difficulty of such determination can be eliminated by considering not only the collision possibility but also the visibility. Even with the same medium collision possibility, when the subject is looking at (or just before) the target object, it is considered that the subject is sufficiently aware of the presence of the target object, and thus it is not necessary to give an unnecessary warning and the subject can pay attention by himself/herself. Conversely, in a case where the subject is not looking at the target object at all, it is sufficient if a warning is issued in such a manner that attention is paid in advance (at least the presence of the target object is recognized) before the collision possibility increases. With the configuration according to the first embodiment including the effective collision possibility calculating unit 70, both the visibility E1 and the collision possibility F1 are evaluated, so that it is possible to eliminate the difficulty of such determination. As described above, the indicator of the effective collision possibility G1 is capable of expressing the difference in whether to cause an action from the vehicle side even with the same medium collision possibility. By the threshold determination for the effective collision possibility G1, it is possible to first determine whether or not to issue a warning. Furthermore, by changing the intensity of the warning depending on the magnitude of the effective collision possibility G1 equal to or more than the threshold used in the threshold determination, it is possible to implement a dynamic warning mode without finely setting threshold levels for different parameters as in Patent Literature 1.

### (Warning Unit)

The warning unit 80 receives the effective collision possibility G1 as an input, and outputs warning information H1 which is control information for controlling a warning operation by a warning device, not illustrated, on the basis of the effective collision possibility G1. The warning information H1 is not output for a target for which the effective collision possibility G1 is lower than the threshold, and the warning information H1 is output when the effective collision possibility is equal to or more than the threshold. Depending on the magnitude of the effective collision possibility G1, the intensity and form of the warning may be changed. Furthermore, a form of the warning may be a visual presentation form, an audio presentation form, or another presentation method that works on five human senses. In a case where the warning form is a visual presentation form, a display is used as the warning device, which is not illustrated. In a case where the warning mode is an audio presentation form, a speaker is used as the warning device, which is not illustrated. In addition, an appropriate device such as a vibration device is used as a warning device, not illustrated, depending on a warning presentation method.

### <Operation>

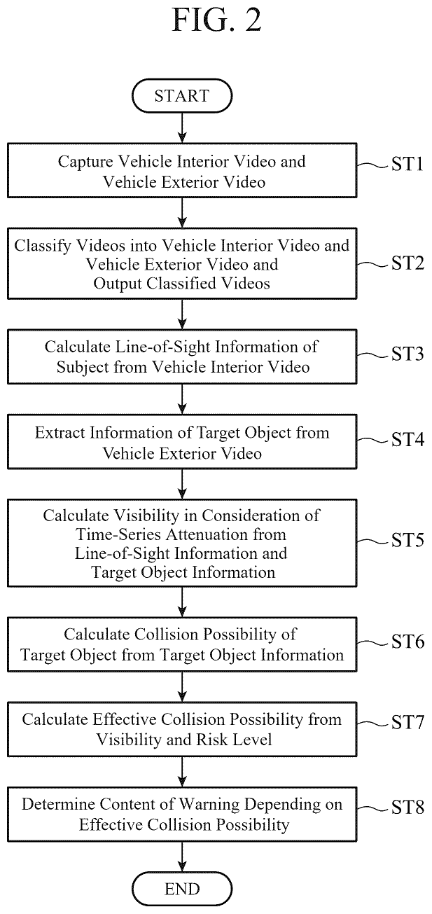

FIG. 2 is a flowchart for describing an operation for providing driving assistance.

In step ST1, the imaging device 10 captures the vehicle interior video A1 including the subject and the vehicle exterior video B1 including the visual target object.

In step ST2, the data input unit 20 receives the obtained videos as inputs, classifies the videos into the vehicle interior video A1 and the vehicle exterior video B1 necessary for calculating the line-of-sight information and the target object information, and outputs the classified videos.

In step ST3, the line-of-sight information calculating unit 30 calculates line-of-sight information C1 of the subject from the vehicle interior video A1.

In step ST4, the target object information calculating unit 40 detects a target object present around the vehicle from the vehicle exterior video and extracts target object information D1 that is information of the target object.

In step ST5, the visibility calculating unit 50 calculates the visibility E1 from the line-of-sight information C1 and the target object information D1. The visibility E1 may be a visibility in consideration of time-series attenuation.

In step ST6, the collision possibility calculating unit 60 calculates the collision possibility F1 of the target object from the target object information D1.

In step ST7, the effective collision possibility calculating unit 70 calculates the effective collision possibility G1 from the visibility E1 and the collision possibility F1.

In step ST8, the warning unit 80 determines the content of the warning depending on the effective collision possibility G1.

### Second Embodiment

### <Configuration>

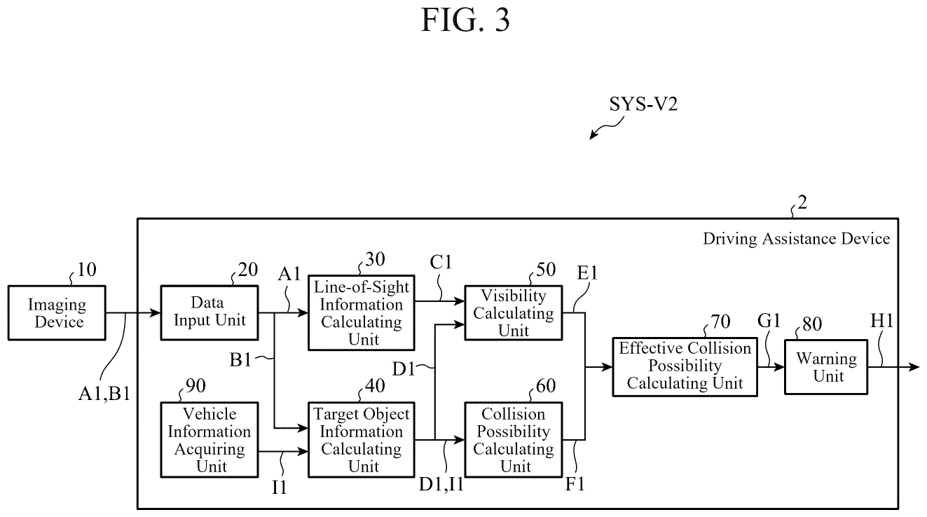

A driving assistance device 2 and a driving assistance system SYS-V2 according to a second embodiment of the present disclosure will be described with reference to FIG. 3. FIG. 3 is a block diagram illustrating the driving assistance device 2 and the driving assistance system SYS-V2 according to the second embodiment of the present disclosure. As illustrated in FIG. 3, the driving assistance system SYS-V2 includes an imaging device 10 that captures a vehicle exterior video including a visual target object and a vehicle interior video including a subject, and a driving assistance device 2.

As an example, the driving assistance device 2 includes a data input unit 20 that receives images captured by the imaging device 10 as inputs, classifies the images into a vehicle interior video and a vehicle exterior video necessary for calculation of line-of-sight information and target object information, and outputs the classified images, a line-of-sight information calculating unit 30 that calculates line-of-sight information of a subject from the vehicle interior video, a target object information calculating unit 40 that detects a target object around the vehicle from the vehicle exterior video and extracts information of the target object, a visibility calculating unit 50 that calculates a visibility in consideration of time-series attenuation from the line-of-sight information and the target object information, a collision possibility calculating unit 60 that calculates a collision possibility of the target object from the target object information, an effective collision possibility calculating unit 70 that calculates an effective collision possibility from the visibility and the collision possibility, a warning unit 80 that determines and presents contents of warning in accordance with the effective collision possibility, and a vehicle information acquiring unit 90 that acquires vehicle information from a control system mounted on a device-mounted vehicle. As in the case of the first embodiment, all the functional units of the driving assistance device 2 may be implemented by a device mounted on the device-mounted vehicle, or only a part of the functional units of the driving assistance device 2 may be implemented by a device mounted on the device-mounted vehicle, and the remaining functional units may be implemented by a device remotely provided.

(Imaging device)

The imaging device 10 includes at least one camera, captures the vehicle interior video A1 including a plurality of frame images including a face image of a subject in the vehicle and the vehicle exterior video B1 including a plurality of frame images including a target object to be visually recognized by the subject, and outputs video data including the vehicle interior video A1 and the vehicle exterior video B1. The vehicle interior video A1 and the vehicle exterior video B1 may be captured as individual videos by using respective single cameras related to the vehicle interior video A1 and the vehicle exterior video B1, or may be captured by using a stereo camera related to each of the vehicle interior video A1 and the vehicle exterior video B1 in order to measure an accurate three-dimensional position. In addition, the vehicle interior video A1 and the vehicle exterior video B1 may be collectively captured in the same video by using a camera capable of capturing a wide range, such as an omnidirectional camera. The imaging device 10 is connected to the data input unit 20 of driving assistance device 1.

### (Data Input Unit)

The data input unit 20 classifies video data including the vehicle interior video A1 and the vehicle exterior video B1 into the vehicle interior video A1 necessary for calculation of line-of-sight information and the vehicle exterior video B1 necessary for calculation of target object information, and outputs the classified vehicle interior video A1 and vehicle exterior video B1. The data input unit 20 is connected to the line-of-sight information calculating unit 30 and the target object information calculating unit 40, outputs the vehicle interior video A1 to the line-of-sight information calculating unit 30, and outputs the vehicle exterior video B1 to the target object information calculating unit 40.

(Vehicle information acquiring unit)

The vehicle information acquiring unit 90 acquires vehicle information 11 of the device-mounted vehicle from a control system mounted on the device-mounted vehicle, and outputs the acquired vehicle information I1. For example, a vehicle speed, steering control information, or pedal control information may be acquired as the vehicle information I1. The vehicle information acquiring unit 90 is connected to the target object information calculating unit 40.

(Line-of-sight information calculating unit)

The line-of-sight information calculating unit 30 receives the vehicle interior video A1 as an input, calculates a line-of-sight vector of the subject from the received vehicle interior video A1, and outputs the calculated line-of-sight vector as line-of-sight information C1. As a method of calculating the line-of-sight vector, a model-based line-of-sight detection method typified by use of a corneal reflection image may be used, or an appearance-based method by machine learning may be used. The line-of-sight information calculating unit 30 is connected to the visibility calculating unit 50.

(Target object information calculating unit)

The target object information calculating unit 40 receives the vehicle exterior video B1 and the vehicle information I1 as inputs, detects a target object that needs to be visually recognized in performing appropriate driving from the received vehicle exterior video B1 and vehicle information I1, and outputs target object information D1 and vehicle information I1 which are information regarding the detected target object. Type information indicating the type of the target object may be used as the target object information D1, such as “fixed indicator” when the target object is a traffic signal, and “moving object” when the target object is an automobile or a pedestrian. When the target object is a fixed indicator, the target object information D1 may further include position information indicating a position of the target object, size information indicating a detected size of the target object, and state information typified by a lighting mode of a light-emitting diode (LED). On the other hand, when the target object is a moving object, the target object information D1 may further include position information indicating the position of the target object, size information indicating the detected size of the target object, and time-series change information (motion information) indicating the traveling direction and speed of the target object. The target object information calculating unit 40 is connected to the visibility calculating unit 50 and the collision possibility calculating unit 60, outputs the target object information D1 to the visibility calculating unit 50, and outputs the target object information D1 and the vehicle information I1 to the collision possibility calculating unit 60.

(Visibility calculating unit)

The visibility calculating unit 50 receives the line-of-sight information C1 and the target object information D1 of the subject as inputs, calculates a visibility E1 to each target using the received line-of-sight information C1 and target object information D1, and outputs the calculated visibility E1. The visibility E1 is an index indicating the extent of the degree to which the subject visually recognizes the detected target object. The visibility calculating unit 50 calculates the visibility E1, for example, as follows.

First, the visibility calculating unit 50 calculates the direction matching degree between the vectors by using the line-of-sight unit vector of the line-of-sight vector and the target unit vector of the target vector from the vehicle toward the target object at each time. As the direction matching degree, the degree of an angle formed by the line-of-sight unit vector and the target unit vector may be used, or the degree of an angle formed by two unit vectors in a displacement direction per unit time of those two unit vectors may be used. The direction matching degree may be an index smoothed per certain time.

Next, the visibility calculating unit 50 goes back by a certain time from the current time toward the past and calculates the sum of direction matching degrees given a weight of each time. The weight may be set to be higher toward the current time, or a non-linear weight may be given. In a case where a state change or a motion change of the target object is observed within a measurement time of the visibility, a correction coefficient is defined for each type of the target object, the direction matching degree before the time when the change of the target object occurs is multiplied by the correction coefficient, and a sum of corrected direction matching degrees within the measurement time is obtained to calculate the visibility. In a case where the target object is a fixed indicator represented by a traffic signal, the correction coefficient may be given by a constant multiple at the time when the instruction content changes. When the target object is a moving object represented by an automobile, a difference between a motion at the start of visibility measurement and a motion at the current time may be calculated, and the correction coefficient may be dynamically defined depending on the amount of the difference. The visibility calculating unit 50 is connected to the effective collision possibility calculating unit 70.

(Collision possibility calculating unit)

The collision possibility calculating unit 60 receives the target object information D1 and the vehicle information I1 as inputs, calculates the collision possibility F1 for each target object using the received target object information D1 and vehicle information I1, and outputs the calculated collision possibility F1. The collision possibility F1 is an index indicating the degree of possibility that the detected target object collides with the device-mounted vehicle. When the collision possibility F1 is calculated, the calculation method may be changed depending on the type of the target object indicated by the type information. For example, in the case of a fixed indicator represented by a traffic signal, a time limit to a stop instruction position is measured from the position and motion information of the target object, and the collision possibility F1 is defined as an index inversely proportional to the time limit. The time limit may be multiplied by a correction coefficient depending on a difference in instruction form from traveling to stopping. Here, examples of the instruction form of the target object include color display of a traffic signal, information on a road by a road information board (traffic congestion, traffic accidents, weather, or the like), and the like. Further, as an example, the motion information is information regarding the speed, acceleration, and traveling direction of the target object. Even if the target object is a fixed object such as a signal, the target object appears to be relatively moving when viewed from a camera attached to the vehicle, and thus motion information is present.

When the target object is a moving object such as an automobile, a time limit until coming into contact with the device-mounted vehicle is measured from the position and motion information of the target object, and the collision possibility F1 is defined as an index inversely proportional to the time limit. Furthermore, in a case where the target object is a moving object, kinetic energy may be calculated, and the collision possibility F1 may be defined as an index proportional to the kinetic energy.

At the time of calculating the motion information, the motion information of the vehicle information I1 and relative motion information of the target object information viewed from the device-mounted vehicle may be combined and replaced with motion information of a real space, or a collision possibility based on future motion predictions of the device-mounted vehicle and the target object may be calculated from the replaced motion information.

In this manner, the collision possibility calculating unit 60 selects at least one of the instruction form or the motion information of the target object depending on the type of the target object, and calculates the collision possibility F1. The collision possibility calculating unit 60 is connected to the effective collision possibility calculating unit 70.

(Effective collision possibility calculating unit)

The effective collision possibility calculating unit 70 receives the visibility E1 and the collision possibility F1 as inputs, calculates the effective collision possibility G1 using the received visibility E1 and collision possibility F1, and outputs the calculated effective collision possibility G1. The effective collision possibility G1 is an index that decreases in accordance with an increase in the visibility E1 and increases in accordance with an increase in the collision possibility F1. The visibility E1, which is such an index, is expressed as, for example, the above-described Expression (1). The effective collision possibility calculating unit 70 is connected to the warning unit 80.

Note that, as described in accordance with the first embodiment, by using such an effective collision possibility G1, various effects such as that the visibility E1 and the collision possibility F1 can be simultaneously evaluated as the effective collision possibility G1 are exhibited.

### (Warning Unit)

The warning unit 80 receives the effective collision possibility G1 as an input, and outputs warning information H1 which is control information for controlling a warning operation by a warning device, not illustrated, on the basis of the effective collision possibility G1. The warning information H1 is not output for a target for which the effective collision possibility G1 is lower than the threshold, and the warning information H1 is output when the effective collision possibility is equal to or more than the threshold. Depending on the magnitude of the effective collision possibility G1, the intensity and form of the warning may be changed. Furthermore, a form of the warning may be a visual presentation form, an audio presentation form, or another presentation method that works on five human senses. In a case where the warning form is a visual presentation form, a display is used as the warning device, which is not illustrated. In a case where the warning mode is an audio presentation form, a speaker is used as the warning device, which is not illustrated. In addition, an appropriate device such as a vibration device is used as a warning device, not illustrated, depending on a warning presentation method.

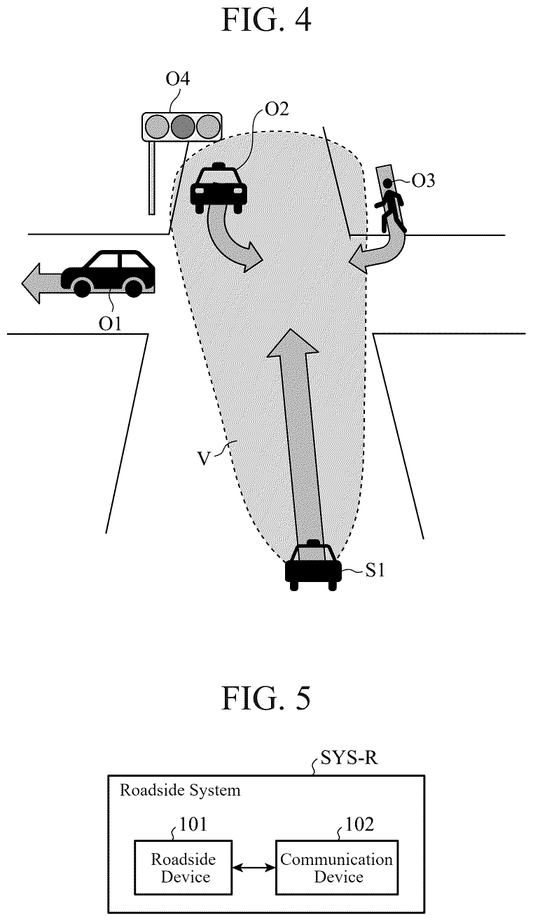

FIG. 4 is a diagram illustrating a concept of the effective collision possibility according to the first embodiment and the second embodiment of the present disclosure by a specific example. As the travel environment illustrated in FIG. 4, it is assumed that target objects O1 to 03 as moving objects and a device-mounted vehicle S1 travel in the directions of arrows attached to the target objects or the vehicles. It is assumed that the possibility of contact with the device-mounted vehicle S1 increases in the range of the region V from the motion state of the device-mounted vehicle S1 and the motion state of the target object. Furthermore, it is assumed that the line-of-sight direction of the subject changes from the target object 03 to 02.

Here, since the traveling direction of the target object O1 is in a direction away from the region V, the collision possibility is calculated to be low. On the other hand, the visibility is also calculated to be low, the effective collision possibility based on Expression (1) is calculated to be low, and no warning is presented.

The target object 02 is traveling in a direction of passing the vehicle and the collision possibility is medium, but the traveling direction is changed on the way and the time until contact is shortened, so that the collision possibility is increased. The subject visually recognizes the target object 02 at the current time, and maintains a state of high visibility. When the target object 02 travels straight, the effective collision possibility is low to medium, but the collision possibility increases due to the direction change of the target object 02, and the effective collision possibility increases. As the effective collision possibility increases, the warning transitions in the direction in which it is displayed, and the presentation intensity gradually increases.

The target object 03 is traveling outside the region V and has a low collision possibility, and the subject takes his/her eyes off after visually recognizing the target object 03 having a low collision possibility once. The effective collision possibility is calculated to be low at the stage of visual recognition by the subject and the warning is not presented, but the motion of the target object 03 changes while the subject takes his/her eyes off, and proceeds toward the region V. The visibility gradually decreases due to the lapse of time while the eyes are kept off and the motion change of the target object, and the collision possibility also increases due to the progress change in the region V direction, so that the effective collision possibility increases, and warning presentation is started. When the traveling direction of the target object 03 is a direction different from the region V, the visibility is attenuated, but the collision possibility is also reduced and the effective collision possibility is maintained at a low level.

It is assumed that the target object 04 is a traffic signal, and there are multiple stages of instruction forms from traveling to a stop instruction. At the timing when the instruction form of the traffic signal changes, the direction matching degree between the line-of-sight vector and the target vector obtained at a time before that time instantaneously decreases, and the visibility decreases. The collision possibility is calculated based on the distance to the stop position and the vehicle speed, but in a case where the collision possibility is low, the effective collision possibility increases moderately, and it is possible to call attention with a margin. On the other hand, when the collision possibility is medium, the effective collision possibility increases to a high degree, and a strong warning is presented.

### Third Embodiment

A road-to-vehicle driving assistance system according to a third embodiment includes the driving assistance device 1 or the driving assistance system SYS-V1 described in the first embodiment, or the driving assistance device 2 or the driving assistance system SYS-V2 described in the second embodiment, and a roadside system SYS-R capable of communicating with the driving assistance device 1 or 2. The roadside system SYS-R includes a roadside device 101 and a communication device 102. The roadside device 101 acquires information of the device-mounted vehicle S1 and target objects around the device-mounted vehicle S1 using, for example, a surveillance camera on the road or a satellite, and transmits the acquired information to the target object information calculating unit 40 of the driving assistance device 1 or 2 via the communication device 102. Detection of a target object around the device-mounted vehicle S1 may be performed only by the roadside device 101, or may be performed by both the roadside device 101 and the vehicle-side device or system (the driving assistance device 1 or the driving assistance system SYS-V1, or the driving assistance device 2 or the driving assistance system SYS-V2). In addition, the roadside device 101 and the vehicle-side device or system (the driving assistance device 1 or the driving assistance system SYS-V1, or the driving assistance device 2 or the driving assistance system SYS-V2) may detect different target objects. Furthermore, the roadside device 101 may receive at least one of the vehicle speed, the steering control information, or the pedal control information from the device-mounted vehicle S1, calculate the collision possibility between the vehicle and the target object, and transmit the possibility to the collision possibility calculating unit 60.

### <Hardware Configuration>

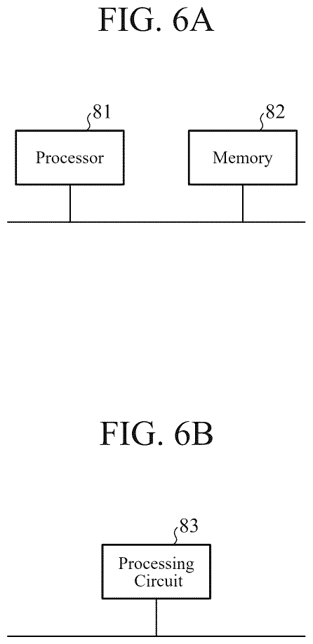

Next, a configuration example of hardware of the driving assistance devices 1 and 2 and the roadside device 101 according to the first to third embodiments will be described with reference to FIG. 6. These devices can be implemented by the control circuit illustrated in FIG. 6A, that is, a processor 81 and a memory 82. An example of the processor 81 is a central processing unit (CPU, also referred to as a processing device, an arithmetic device, a microprocessor, a microcomputer, a processor, or a digital signal processor (DSP)) or a system large scale integration (LSI). The memory 82 is, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a MiniDisc, a digital versatile disk (DVD), or the like. The driving assistance device 1 or 2 or the roadside device 101 is implemented by the processor 81 reading and executing a program stored in the memory 82. The program executed by the processor 81 may be a file in an installable format or an executable format, stored in a computer-readable storage medium, and provided as a computer program product. In addition, the program executed by the processor 81 may be provided to the driving assistance device via a network such as the Internet.

As another example, the driving assistance devices 1 and 2 and the roadside device 101 according to the first to third embodiments may be implemented by a dedicated processing circuit 83 illustrated in FIG. 6B. The processing circuit 83 is dedicated hardware. The processing circuit 83 is, for example, a single circuit, a composite circuit, a programmed processor, a parallel programmed processor, an application specific integrated circuit (ASIC), a field-programmable gate array (FPGA), or a combination thereof.

Note that part of the functions of the driving assistance device 1 or 2 or the roadside device 101 may be implemented by software or firmware, and the remaining part may be implemented by dedicated hardware.

### <Supplementary Note>

Some aspects of the various embodiments described above are summarized as follows.

### (Supplementary Note 1)

A driving assistance device according to supplementary note 1 includes a line-of-sight information calculating unit (30) to calculate line-of-sight information of a subject from a vehicle interior video about inside a vehicle captured by an imaging device including at least one camera, a target object information calculating unit (40) to detect a target object present around the vehicle from a vehicle exterior video about outside the vehicle captured by the imaging device and extract target object information that is information of the detected target object, a visibility calculating unit (50) to calculate a visibility indicating an extent of a degree of visual recognition of the detected target object by the subject from the calculated line-of-sight information and the extracted target object information, a collision possibility calculating unit (60) to calculate a collision possibility indicating an extent of a degree of collision possibility between the detected target object and the vehicle from the extracted target object information, and an effective collision possibility calculating unit (70) to calculate an effective collision possibility that decreases in accordance with an increase in the calculated visibility and increases in accordance with an increase in the calculated collision possibility from the calculated visibility and the calculated collision possibility.

With the driving assistance device of supplementary note 1, determination is performed using the effective collision possibility that simultaneously evaluates the visibility and the collision possibility. Therefore, by performing warning on the basis of the effective collision possibility, it is possible to perform warning in which the visibility and the collision possibility are simultaneously evaluated. In addition, by performing threshold determination on the effective collision possibility, it is sufficient to satisfy lower visibility for a target object having a lower collision possibility, and thus it is possible to suppress an unnecessary warning that may annoy the user.

In addition, since the effective collision possibility is defined as an index reflecting both the visibility and the collision possibility, it is possible to dynamically determine the presence or absence of a warning and adjust the strength thereof depending on the visibility even for a target having a low to medium collision possibility. Thus, it is possible to present a warning with appropriate intensity for a target object that truly requires attention or handling while reducing annoyance.

### (Supplementary Note 2)

A driving assistance device according to supplementary note 2 is the driving assistance device according to supplementary note 1, further including a warning unit (80) to determine a content of a warning to be performed for the subject in accordance with the calculated effective collision possibility and control a warning operation by a warning device.

With the driving assistance device of supplementary note 2, it is possible to control the warning operation for the subject in accordance with the effective collision possibility.

### (Supplementary Note 3)

A driving assistance device according to supplementary note 3 is the driving assistance device according to supplementary note 1 or 2, further including a vehicle information acquiring unit (90) to acquire at least one of a vehicle speed, steering control information, or pedal control information as vehicle information from a control system mounted on the vehicle, in which the collision possibility calculating unit calculates the collision possibility on the basis of the extracted target object information and the acquired vehicle information.

With the driving assistance device of supplementary note 3, the motion of the target object in a real space can be calculated by using the motion information of the device-mounted vehicle in addition to the relative motion of the surrounding target object viewed from the device-mounted vehicle obtained from the vehicle exterior video, and calculation accuracy of the collision possibility regarding an approach and contact between objects is improved from motion prediction of the target object and motion prediction of the device-mounted vehicle.

### (Supplementary Note 4)

A driving assistance device according to supplementary note 4 is the driving assistance device according to any one of supplementary notes 1 to 3, in which the visibility calculating unit calculates a direction matching degree between a direction of a target vector from the vehicle toward the target object and a direction of a line-of-sight vector of the subject at a predetermined timing, calculates a weighted direction matching degree by adding a weight to a direction matching degree at each time within a past fixed time from a current time, calculates, when a change in state or motion of the target object occurs within a measurement time, a corrected direction matching degree, which is corrected, by multiplying the calculated, weighted direction matching degree before an occurrence time of the change by a coefficient, and calculates the visibility by calculating a sum of the calculated, weighted direction matching degrees or the calculated, corrected direction matching degree.

With the driving assistance device of supplementary note 4, since the visibility is obtained on the basis of the weighted direction matching degree by adding the weight to the direction matching degree at each time within the past fixed time from the current time, it is possible to reflect temporal attenuation of a memory of the target object, which occurs when the subject turns his/her line of sight from the target object, on the visibility. Furthermore, it is possible to adjust the intensity of attenuation with time by giving a weight that becomes higher as it is closer to the current time. Moreover, by providing a coefficient related to a change in state or a change in motion in a surrounding target object, it is possible to reflect, on the visibility, a state in which the subject cannot grasp a behavior change of the target object after visually recognizing the target object once.

### (Supplementary Note 5)

A driving assistance device according to supplementary note 5 is the driving assistance device according to any one of supplementary notes 1 to 4, in which the target object information calculating unit calculates type information indicating a type of the detected target object and state information indicating a state or motion information indicating a motion.

With the driving assistance device of supplementary note 5, since the type information indicating the type of the detected target object is calculated, it is possible to calculate the visibility and the collision possibility by the index for each type of target object.

### (Supplementary Note 6)

A driving assistance device of supplementary note 6 is the driving assistance device according to supplementary note 5, in which the collision possibility calculating unit calculates the collision possibility on the basis of at least one of the calculated state information or motion information according to the calculated type information.

With the driving assistance device of supplementary note 6, in a case where the target object is a fixed indicator such as a traffic signal, it is possible to calculate the collision possibility according to the lighting state of the LED and the distance to the fixed indicator, and in a case of a moving object such as an automobile, it is possible to calculate the collision possibility according to the motion information, and it is possible to calculate each collision possibility even for target objects of different types.

### (Supplementary Note 7)

A road-to-vehicle driving assistance system according to supplementary note 7 is a road-to-vehicle driving assistance system including the driving assistance device (1; 2) according to any one of supplementary notes 1 to 6 and a roadside system (SYS-R) capable of communicating with the driving assistance device, in which the roadside system transmits, to the driving assistance device, information of the target object or another target object present around the vehicle different from the target object, and the target object information calculating unit of the driving assistance device extracts the target object information on the basis of the vehicle exterior video and the transmitted information.

### (Supplementary Note 8)

A driving assistance method of supplementary note 8 is a driving assistance method performed by a driving assistance device including a line-of-sight information calculating unit (30), a target object information calculating unit (40), a visibility calculating unit (50), a collision possibility calculating unit (60), and an effective collision possibility calculating unit (70), the driving assistance method including a step (ST3) of calculating, by the line-of-sight information calculating unit, line-of-sight information of a subject from a vehicle interior video about inside a vehicle captured by an imaging device including at least one camera, a step (ST4) of detecting, by the target object information calculating unit, a target object present around the vehicle from a vehicle exterior video about outside the vehicle captured by the imaging device and extracting target object information that is information of the detected target object, a step (ST5) of calculating, by the visibility calculating unit, a visibility indicating an extent of a degree of visual recognition of the detected target object by the subject from the calculated line-of-sight information and the extracted target object information, a step (ST6) of calculating, by the collision possibility calculating unit, a collision possibility indicating an extent of a degree of collision possibility between the detected target object and the vehicle from the extracted target object information, and a step (ST7) of calculating, by the effective collision possibility calculating unit, an effective collision possibility that decreases in accordance with an increase in the calculated visibility and increases in accordance with an increase in the calculated collision possibility from the calculated visibility and the calculated collision possibility.

### (Supplementary Note 9)

A driving assistance program of supplementary note 9 includes a step (ST3) of calculating line-of-sight information of a subject from a vehicle interior video about inside a vehicle captured by an imaging device including at least one camera, a step (ST4) of detecting a target object present around the vehicle from a vehicle exterior video about outside the vehicle captured by the imaging device and extracting target object information that is information of the detected target object, a step (ST5) of calculating a visibility indicating an extent of a degree of visual recognition of the detected target object by the subject from the calculated line-of-sight information and the extracted target object information, a step (ST6) of calculating a collision possibility indicating an extent of a degree of collision possibility between the detected target object and the vehicle from the extracted target object information, and a step (ST7) of calculating an effective collision possibility that decreases in accordance with an increase in the calculated visibility and increases in accordance with an increase in the calculated collision possibility from the calculated visibility and the calculated collision possibility.

Note that the embodiments can be combined, and each of the embodiments can be appropriately modified or omitted.

### INDUSTRIAL APPLICABILITY

The driving assistance device of the present disclosure can be used as a device that assists driving of a vehicle.

### REFERENCE SIGNS LIST

1: driving assistance device, 2: driving assistance device, 10: imaging device, 20: data input unit, 30: line-of-sight information calculating unit, 40: target object information calculating unit, 50: visibility calculating unit, 60: collision possibility calculating unit, 70: effective collision possibility calculating unit, 80: warning unit, 81: processor, 82: memory, 83: processing circuit, 90: vehicle information acquiring unit, 101: roadside device, 102: communication device, SYS-R: roadside system, SYS-V1: driving assistance system, SYS-V2: driving assistance system.

1. A driving assistance device comprising:
processing circuitry
to calculate line-of-sight information of a subject from a vehicle interior video about inside a vehicle captured by an imaging device including at least one camera;
to detect a target object present around the vehicle from a vehicle exterior video about outside the vehicle captured by the imaging device and extract target object information that is information of the detected target object;
to calculate, from the calculated line-of-sight information and the extracted target object information, a visibility indicating an extent of a degree of visual recognition of the detected target object by the subject at each time within a past fixed time period from a current time, to correct the calculated visibility on a basis of a lapse of time from the current time to each time within the past, to recorrect the corrected visibility on a basis of a state change of the target object, and to calculate a visibility associated to the current time on a basis of the recorrected visibility;
to calculate a collision possibility indicating an extent of a degree of collision possibility between the detected target object and the vehicle from the extracted target object information; and
to calculate an effective collision possibility that decreases in accordance with an increase in the calculated visibility and increases in accordance with an increase in the calculated collision possibility from the calculated visibility and the calculated collision possibility.

2. The driving assistance device according to claim 1, wherein the processing circuitry is further configured
to determine a content of a warning to be performed for the subject in accordance with the calculated effective collision possibility and control a warning operation by a warning device.

3. The driving assistance device according to claim 1, wherein the processing circuitry is further configured
to acquire at least one of a vehicle speed, steering control information, or pedal control information as vehicle information from a control system mounted on the vehicle, and
to calculate the collision possibility on a basis of the extracted target object information and the acquired vehicle information.

4. (canceled)

5. The driving assistance device according to claim 1, wherein
the processing circuitry is further configured to calculate type information indicating a type of the detected target object and state information indicating a state or motion information indicating a motion.

6. The driving assistance device according to claim 5, wherein
the processing circuitry is further configured to calculate the collision possibility on a basis of at least one of the calculated state information or motion information according to the calculated type information.

7. A road-to-vehicle driving assistance system, comprising:
the driving assistance device according to claim 1; and
a roadside system capable of communicating with the driving assistance device, wherein
the roadside system transmits, to the driving assistance device, information of the target object or another target object present around the vehicle different from the target object, and
the driving assistance device extracts the target object information on the basis of the vehicle exterior video and the transmitted information.

8. A driving assistance method performed by a driving assistance device, the driving assistance method comprising:
calculating line-of-sight information of a subject from a vehicle interior video about inside a vehicle captured by an imaging device including at least one camera;
detecting a target object present around the vehicle from a vehicle exterior video about outside the vehicle captured by the imaging device and extracting target object information that is information of the detected target object;
calculating a visibility, from the calculated line-of-sight information and the extracted target object information, a visibility indicating an extent of a degree of visual recognition of the detected target object by the subject at each time within a past fixed time period from a current time, to correct the calculated visibility on a basis of a lapse of time from the current time to each time within the past, to recorrect the corrected visibility on a basis of a state change of the target object, and to calculate a visibility associated to the current time on a basis of the recorrected visibility;
calculating a collision possibility indicating an extent of a degree of collision possibility between the detected target object and the vehicle from the extracted target object information; and
calculating an effective collision possibility that decreases in accordance with an increase in the calculated visibility and increases in accordance with an increase in the calculated collision possibility from the calculated visibility and the calculated collision possibility.

9. (canceled)

10. A driving assistance device comprising:
processing circuitry
to calculate line-of-sight information of a subject from a vehicle interior video about inside a vehicle captured by an imaging device including at least one camera;
to detect a target object present around the vehicle from a vehicle exterior video about outside the vehicle captured by the imaging device and extract target object information that is information of the detected target object;
to calculate a visibility indicating an extent of a degree of visual recognition of the detected target object by the subject from the calculated line-of-sight information and the extracted target object information;
to calculate a collision possibility indicating an extent of a degree of collision possibility between the detected target object and the vehicle from the extracted target object information; and
to calculate an effective collision possibility that decreases in accordance with an increase in the calculated visibility and increases in accordance with an increase in the calculated collision possibility from the calculated visibility and the calculated collision possibility, wherein
the processing circuitry is further configured
to calculate a direction matching degree between a direction of a target vector from the vehicle toward the target object and a direction of a line-of-sight vector of the subject at a predetermined timing,
to calculate a weighted direction matching degree by adding a weight to a direction matching degree at each time within a past fixed time from a current time,
to calculate, when a change in state or motion of the target object occurs within a measurement time, a corrected direction matching degree, which is corrected, by multiplying the calculated, weighted direction matching degree before an occurrence time of the change by a coefficient, and
to calculate the visibility by calculating a sum of the calculated, weighted direction matching degrees or the calculated, corrected direction matching degree.
